(19) United States
(12) Patent Application Publication
(10) Pub. No.: US 2018/0060821 A1
(43) Pub. Date: Mar. 1, 2018

(54) EMPLOYEE REFERRAL SYSTEM

(71) Applicant: Joseph Ziccardi, Blue Point, NY (US)

(72) Inventor: Joseph Ziccardi, Blue Point, NY (US)

(21) Appl. No.: 15/249,139

(22) Filed: Aug. 26, 2016

(51) Int. Cl. G06Q 10/10; G06Q 30/02

(52) U.S. Cl. CPC G06Q 10/1053; G06Q 30/0276; G06Q 30/0214

(57) ABSTRACT

A web-based employee referral computer-implemented system for targeting specific group of employees, and providing rewards based on the action or events participated by the employee in various steps of the recruiting process is disclosed. The system comprises an employer module, an employee module and an administrator module. The employer module is a web server based system configured to create, monitor, and control the sub-modules of the employee referral system. The employee module is a mobile device configured to receive the job advertisement with a communication and referral options with a status of the reward points from the employer module. The communication option in the advertisement enables the employee to share the advertisements, and the referral option in the advertisement enables the employee to send the data of a referral to the employer. The administrator module is a cloud device configured to manage the employer and the employee modules by a service provider.

### BACKGROUND

The present invention generally relates to a referral tool, and more particularly relates to an employee referral system targeting specific groups of employees implemented using a webserver-based technology. The present invention also relates to a system providing rewards based on the action or events participated by the employee in various steps of the recruiting process.

Employee referral systems are an internal recruitment method incorporated by a company to identify potential candidates from their existing employees' reference. The employee referral system encourages the existing employees to select and recruit the suitable candidates from their social networks. As a reward, the employer typically pays the referring employee a referral bonus or any kind of reward points. Recruiting candidates using employee referral systems are widely acknowledged as being the most cost effective and efficient recruitment method to recruit the candidates.

Generally, a hiring manager sends a job description on an open job, and promises some types of reward on recruiting their referred candidate to the employees via email or posted on the company's internal web portal. Most of these computer-implemented employee referral systems rely on an algorithmic matching technology or a social media based sharing mechanism with an attached reward system to reach out to the employees. Some of the proposed prior art systems attempt to effectively reach out to the employees are, Marshall et. al., U.S. patent application Ser. No. 11/113,430, discloses a referral and recruitment system where users could post new jobs, make direct referrals to collect the entire hiring incentive, or pass along the information to their private contacts to share later in the incentives.

Dominique et. al., U.S. patent application Ser. No. 13/761,860, describes a system for generating and maintaining a private talent network where member may share job information with other members of the network or non-members, such as their friends on social media sites, via email, text or any other suitable communication mechanism.

Lajoie, U.S. patent application Ser. No. 13/497,165, describes a method which allows finding candidates for job offers using a reward scheme, in which members of the public provide contact information on the potential candidates for available job offers. The rewards scheme allows reward sharing of “third party” submitters as well as a “bounty” for headhunters.

Gurion et. al., U.S. patent application Ser. No. 12/907,404, describes a recruiting tool for leveraging social and business contacts of existing employee's contact data such as a basic address, phone number, existing social networks or email address. If any appropriate contact is found, the employee notifies the contact with the help of a message.

Most of the prior art systems either rely on an algorithmic matching technology or a social media based sharing mechanism with attached reward points. The known system utilizes hiring manager email records, social media contacts, third party's web portal, job hunting professional contacts or any public contacts to send a job advertisement. Sometimes, these job advertisements may be annoying to the people, if the advertised job is irrelevant to their field. The main limitation of this system lacks in utilizing the employees who are not using computers in their regular job activities, for example, welders, carpenters, drivers, plumbers, etc. Further, there is no defined reward method followed in the existing system to motivate the referral process among the employees.

Therefore, there exists a need for a simple and automatic employee referral system to target a specific relevant group of employees for the referral process to a specific job opening. Further, the system should reach an audience of employees, who are not using computers or not able to own a computer. Further, there is also a need for a system to provide rewards based on the action or events participated by the employee in various steps of the recruiting process.

### SUMMARY

The present invention relates to a web based system, which delivers a job advertisement via message to a selective clientele of a specific targeted group of employees. In one embodiment, the web-based employee referral is a computer-implemented system, which comprises processor-executable instructions. When executed by at least one processor, the computer-implemented system comprises an employer module, an employee module and an administrator module. In one embodiment, the employee referral system utilizes a software licensing and delivery model, in which the software is licensed on a subscription basis, centrally hosted, and accessible by one or more users using multiple selective clientele via a web browser. In one embodiment, the clients are selective clients of the employer module, employee module or an administrator module. In one embodiment, the selective clients are any computing and network devices such as computers, mobile phones, etc.

In an embodiment, the employer module includes a web server system via a network connection, is configured to create, monitor and control one or more sub-modules of the employee referral system. In one embodiment, the employer module comprises an employee segmentation sub-module, an employee record sub-module, an advertisement sub-module, a campaign sub-module, and a reward sub-module. In an embodiment, the employee segmentation sub-module is configured to create one or more groups for the employees. In one embodiment, the employee segmentation sub-module is configured to define the groups by one or more categories for the employees.

In an embodiment, the employee record sub-module is configured to upload or send one or more data of the employees into a database of the employee referral system. In one embodiment, the employee record sub-module is configured to assign one or more employees from the database to each category of the groups. In one embodiment, the employee record sub-module is implemented to assign one or more reward points for the employee to accomplish a preset actions or events. In another embodiment, the employee record sub-module is also configured to redeem the reward points to the employee accomplishing the preset actions or subsequent events such as interviewing or hiring (events) that result from the employee's action(s) and participating in the recruitment process.

In an embodiment, the advertisement sub-module is configured to generate a job advertisement using one or more templates and forms from the database of the system. In one embodiment, the templates and forms are sourced from any known open source network. In an embodiment, the advertisement sub-module is configured to upload one or more multimedia data in the advertisement. In one embodiment, the multimedia data is relevant to the job are audio, video or in combination thereof. In an embodiment, the advertisement sub-module is configured to provide a communication option in the advertisement for the employee to share the advertisement. In another embodiment, the advertisement sub-module is also configured to provide a referral option in the advertisement for the employee to send one or more data of a referral to the employer. In an embodiment, the advertisement sub-module is configured to display and store the generated job advertisement in the database.

In an embodiment, the advertisement sub-module is further provided with an option to share the advertisement via message in a social network or contacts in the device of the employee. In one embodiment, the advertisement sub-module further comprises information one or more open and closed jobs.

In an embodiment, the campaign sub-module is configured to select the generated job advertisement retrieved from the database. In one embodiment, the campaign sub-module is configured to select the groups and categories of the employees relevant to the job advertisement. In one embodiment, the campaign sub-module is configured to send the job advertisement via message to the mobile device of the selected employees. In one embodiment, the campaign sub-module is configured to send the job advertisement via a text messaging application program interface (API) to the mobile devices of the selected employees. In one embodiment, the campaign sub-module is configured to send a link pointing to the job advertisement in the web server, via text message to the mobile device of the selected employees.

In an embodiment, the reward sub-module is configured to set the reward points for accomplishing one or more preset actions or events for the referral by the employees. In one embodiment, the reward sub-module is configured to define and customize the reward points for accomplishing one or more preset actions for the referral by the employees. In one embodiment, the reward sub-module is configured to define and customize the reward points for customizable employer/candidate preset events. In one embodiment, the reward sub-module is also configured to display a status of the reward points for accomplishing one or more preset actions for the referral by the employees.

In an embodiment, the employee module includes a mobile device, is configured to receive the job advertisement or a text message containing a link to the same, and status of the reward points from the employer module. In one embodiment, the communication option in the advertisement enables the employee to share the advertisements to their contacts via messaging, social network or professional network. In one embodiment, the contacts are employee's friend, relatives, colleague of previous employer or any known jobseekers. In one embodiment, the referral option in the advertisement enables the employee to send the data of the referrals to the employer.

In an embodiment, the employee module further comprises a reward sub-module and a query sub-module. In one embodiment, the reward sub-module comprises information on awarded and redeemed reward points, and a reward brochure. In one embodiment, the query sub-module comprises a form to raise query from the employee.

In an embodiment, the administrator module includes a cloud device comprising one or more sub-modules, configured to manage the employer and the employee modules by a service provider. In one embodiment, the administrator module further comprises a manage employer sub-module, an activity tracking sub-module, and a billing and payment sub-module. In one embodiment, the manage employer sub-module is configured to add, edit or delete one or more employer information. In one embodiment, the employer information includes company name, department, name, billing, and contact information. In one embodiment, the activity-tracking sub-module is configured to view, monitor, and extract one or more data. In one embodiment, the billing and payment sub-module is configured to provide an option for the employer/customer to view the status of the billing and payment.

Other objects, features and advantages of the present invention will become apparent from the following detailed description. It should be understood, however, that the detailed description and the specific examples, while indicating specific embodiments of the invention, are given by way of illustration only, since various changes and modifications within the spirit and scope of the invention will become apparent to those skilled in the art from this detailed description.

### BRIEF DESCRIPTION OF DRAWINGS

FIG. 1A-1D illustrates a block diagram of an employee referral system according to an embodiment.

FIG. 1A illustrates an employee segmentation, an employee record and a reward sub-modules of a module in the system.

FIG. 1B illustrates a job advertisement sub-module of an employer module in the system according to an embodiment.

FIG. 1C illustrates a campaign sub-module of the employer module in the system according to an embodiment.

FIG. 1D illustrates an administrative module in the system according to an embodiment.

FIG. 2A-2B illustrates a flowchart of a method for an employee referral according to an embodiment.

### DETAILED DESCRIPTION

A description of embodiments of the present invention will now be given with reference to the Figures. It is expected that the present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

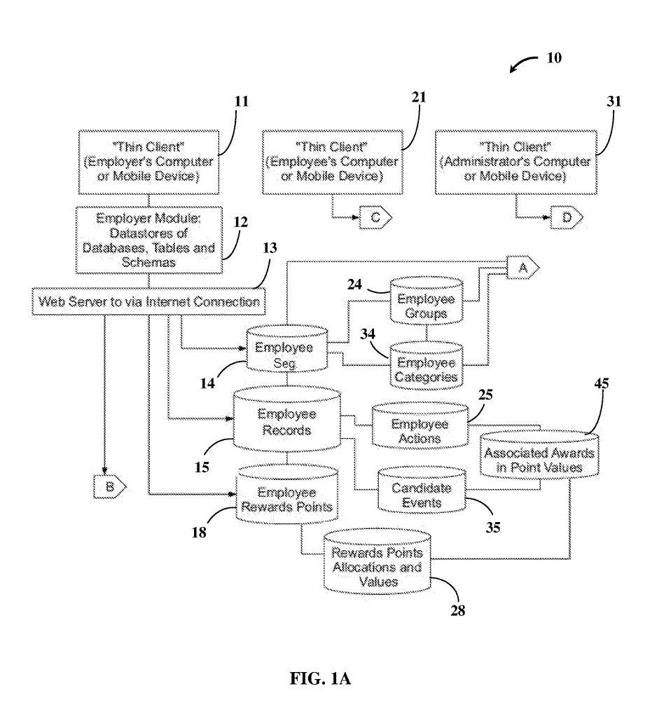

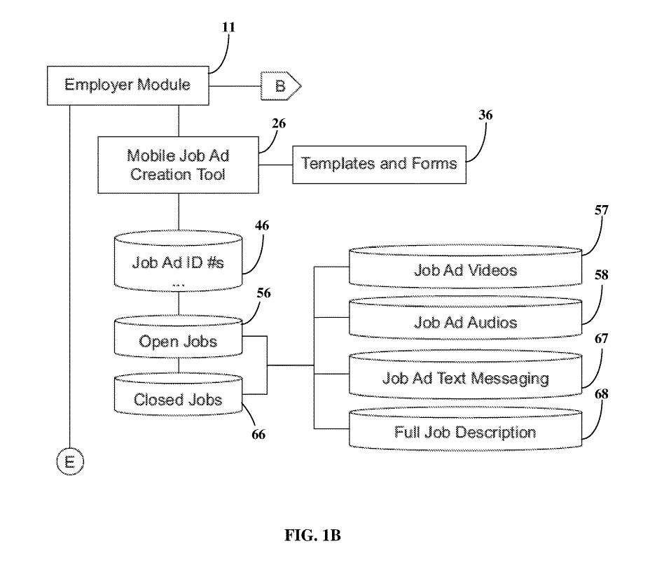

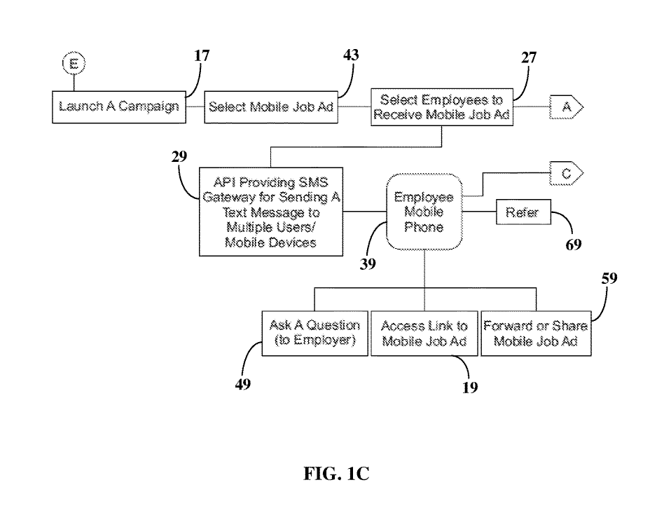

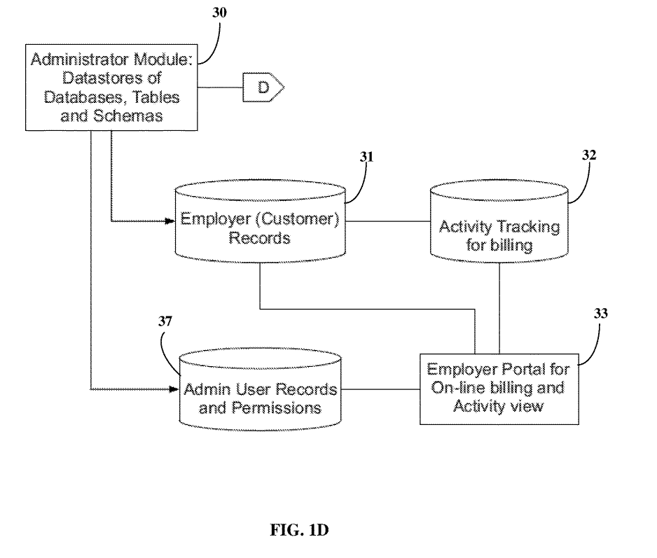

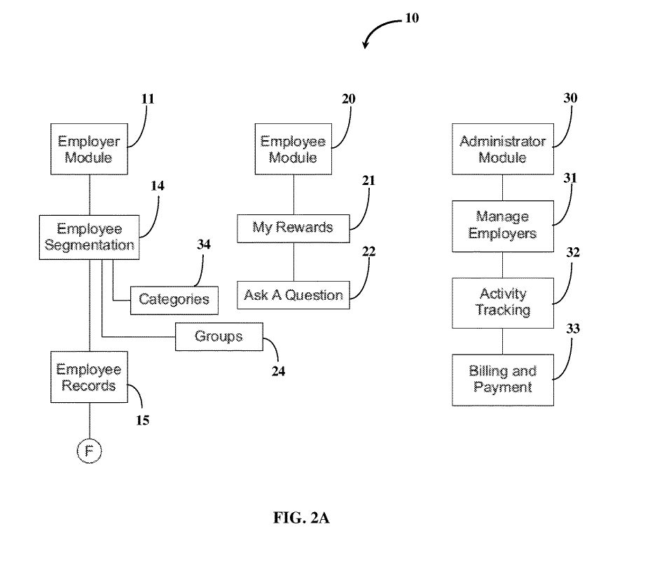

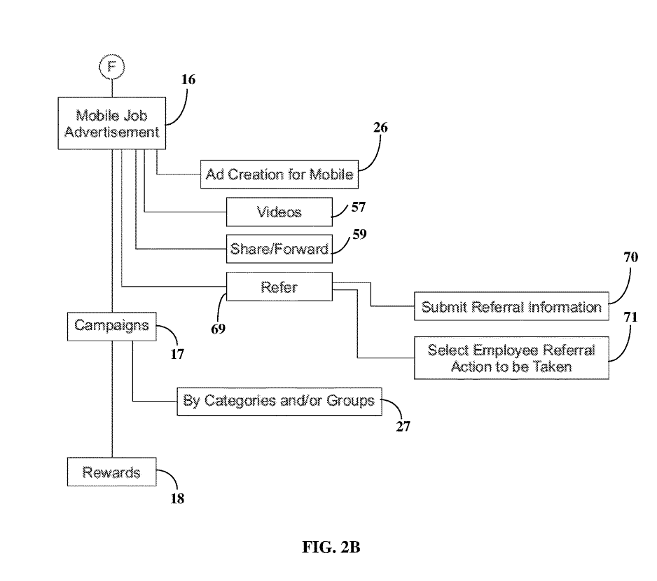

Referring to FIG. 1A-1D, the present invention relates to a web based system 10, which delivers a specific job advertisement via message to a specific targeted group of employees. Referring to FIG. 2A-2B, which illustrates a flowchart of a method for an employee referral, which is implemented in the system 10 as shown in FIG. 1A-1D. In an embodiment, the web-based employee referral system 10 is a computer-implemented system which comprises an employer module 11, an employee module 20, and an administrator module 30. In one embodiment, the employee referral system utilizes a software licensing and delivery model, in which the software is licensed on a subscription basis, centrally hosted, and accessible by one or more users using the selective client via a web browser. In an embodiment, the selective client is the selective client of the employer module, employee module, or an administrator module. In one embodiment, the selective clients are any computing and network devices such as computers, laptops, palmtops, smartphones, mobile phones, etc.

Referring to FIG. 1A, an employer module 11 comprises plurality of data stores of databases, tables, and schemas 12, a web server via network connection 13, is configured to create, monitor and control multiple sub-modules of the employee referral system 10. In one embodiment, the employer module 11 comprises an employee segmentation sub-module 14, an employee record sub-module 15, an advertisement sub-module 16, a campaign sub-module 17, and a reward sub-module 18. In an embodiment, the employee segmentation sub-module 14 is configured to create one or more specific groups 24 for the employees. In one embodiment, the employee segmentation sub-module 14 is configured to define the groups 24 by one or more categories 34 for the employees.

In an embodiment, the employee record sub-module 15 is configured to upload or send data of the employees into a database of the employee referral system 10. In one embodiment, the employee record sub-module 15 is configured to assign one or more employees from the database to each category 34 of the groups 24. In one embodiment, the employee record sub-module 15 is implemented to assign or allocate reward points for the employee to accomplish a preset actions or events. In an embodiment, the preset actions or events are based on an employee action 25, or an employer-candidate event 35. In one embodiment, the employee actions 25, or the employer-candidate events 35 are associated in reward point values 45 for the accomplished preset actions or events for the employee. In another embodiment, the employee record sub-module 15 is also configured to redeem the reward points to the employee accomplishing the preset action or having an event occur subsequent to one of those preset actions, and resulting from participating in the recruitment process of the referred candidate.

Referring to FIG. 1B, the advertisement sub-module 16 comprises an advertisement creation tool 26, which is configured to generate a job advertisement using one or more templates and forms 36 from the database of the system. In one embodiment, the templates and forms 36 are sourced from any known open source network. In an embodiment, the advertisement creation tool 26 is configured to generate the job advertisement in the mobile device 39. In one embodiment, the advertisement creation tool 26 is configured to generate the job advertisement identifications 46 as an open job 56 or a closed job 66 in the mobile device 39.

In an embodiment, the advertisement sub-module 16 is configured to upload one or more multimedia data in the advertisement of the open job 56 or closed job 66 in the mobile device 39. In one embodiment, the multimedia data is relevant to the job advertisement video 57, audio 58, or in combination thereof. In one embodiment, the video 57, or audio 58 is relevant to the job, work culture, or to the employer. In an embodiment, advertisement sub-module 16 is further configured to provide the job advertisement in a text-message format 67 with a link to the multimedia data in the mobile device 39. In one embodiment, advertisement sub-module 16 is further configured to provide the job description 68 of the open job 56 or closed job 66 in the mobile device 39.

In an embodiment, the advertisement sub-module 16 is configured to provide a communication option 59 in the advertisement for the employee to share the advertisement. In an embodiment, the advertisement sub-module 16 is further provided with the communication option to share the advertisement via message or posting in a social network, or forwarding the message to the contacts in the mobile device 39 of the employee. In an embodiment, the advertisement sub-module 16 is also configured to provide a referral option 69 in the advertisement for the employee to submit 70 one or more data of a referral to the employer. In one embodiment, the referral option 69 also comprises a specific option for the employee to select 70 the mode of contacting the referral along with the number of points to be awarded for the specific action, which is communicated to the employer for approaching the referred candidate by the employee. The actions are designed to award points to employees in such a way that the employee is awarded more points for taking a larger role or more responsibility in the recruiting process. In one embodiment, the advertisement sub-module 16 is configured to display and store the generated job advertisement in the database.

Referring to FIG. 1C, the campaign sub-module 17 is configured to select the generated job advertisement 43 retrieved from the database. In one embodiment, the campaign sub-module 17 is configured to select the groups and categories 27 of the employees relevant to the job advertisement. In one embodiment, the campaign sub-module 17 is configured to send the job advertisement via message to the mobile device 39 of the selected employees. In one embodiment, the campaign sub-module 17 is configured to send the job advertisement via a text messaging application program interface (API) 29 to the mobile devices 39 of the selected employees. The API 29 may be any known API in the art, which provides gateway for sending a text message to multiple users/mobile devices. In one embodiment, the campaign sub-module 17 is configured to send the selected job advertisement via text message with a link to the job advertisement 25 to the mobile device 39 of the selected employees.

In an embodiment, the campaign sub-module 17 is configured to provide a communication option 59 in the advertisement for the employee to share the advertisement. In an embodiment, the campaign sub-module 17 is further provided with the communication option 59 to share the advertisement via message or posting in a social network, or forwarding the message to the contacts in the mobile device 39 of the employee. In one embodiment, the communication option 59 further comprises an option for raising a query 49 to the employer. In one embodiment, the communication option 59 further comprises an option for accessing link 17 to the mobile job advertisement to the employee. In an embodiment, the campaign sub-module 17 is also configured to provide a referral option 69 in the advertisement for the employee to send one or more data of a referral to the employer. In one embodiment, the referral option 69 comprises a specific option for the employee to select the mode of contacting the referral along with the number of points to be awarded for the specific action, which is communicated to the employer for approaching the referred candidate by the employee.

Referring to FIG. 1A-D, the reward sub-module 18 is configured to set the reward points 28 for accomplishing one or more preset actions or events for the referral by the employees. In one embodiment, the preset action or event is based on an employee action 25, or a candidate event 35. In one embodiment, the employee actions 25, or the candidate events 35 are associated in reward point values 45 for the accomplished preset action or event for the employee. In another embodiment, the reward sub-module 18 is also configured to redeem the reward points to the employee accomplishing the preset action or event for recruiting a referred candidate. In one embodiment, the reward sub-module 18 is configured to define and customize the reward points for accomplishing one or more preset actions or events for the referral by the employees. In one embodiment, the reward sub-module 18 is configured to define and customize the reward points for customizable employer/candidate preset events, for example, conducting an interview or a hire (events) for a referral as a result of the employee's action(s). In one embodiment, the reward sub-module 18 is also configured to display a status of the reward points for accomplishing one or more preset actions or events for the referral by the employees.

Referring to FIG. 1A-D and FIG. 2A-B, the employee module 20 includes a mobile device 39, is configured to receive the job advertisement and status of the reward points from the employer module 11. In one embodiment, the communication option 59 in the advertisement enables the employee to share the advertisements to their contacts via messaging, social network or professional network. In one embodiment, the contacts are employee's friends, relatives, colleagues of a previous employer or any known jobseekers. In one embodiment, the referral option 69 in the advertisement enables the employee to send or upload the data of the candidate to the employer. In an embodiment, the employee module 20 further comprises a reward status sub-module 21 and a query sub-module 22. In one embodiment, the reward status sub-module 21 comprises information on awarded and redeemed reward points, and a reward brochure. In one embodiment, the query sub-module 22 comprises a form to raise query from the employee.

Referring to FIG. 1D and FIG. 2A-B, the administrator module 30 with a data source of databases, tables and schemas is a cloud device comprising one or more sub-modules, configured to manage the employer and the employee modules by a service provider. In one embodiment, the administrator module further comprises a manage employer sub-module 31, an activity tracking sub-module 32, and a billing and payment sub-module 33. In one embodiment, the manage employer sub-module 31 is configured to add, edit or delete one or more employer information. In one embodiment, the employer information includes company name, department, name, billing, and contact information. In one embodiment, the activity-tracking sub-module 32 is configured to view, monitor, and extract one or more data. In an embodiment, the administrator module comprises a plurality of administrator user records and permissions 37. In one embodiment, the billing and payment sub-module 33 is configured to provide an option for the employer/customer to view the status of the billing and payment.

The advantage of the proposed system is the implementation of a simple and automatic referral process to target a specific relevant group of employees to a specific job opening. The proposed system also reaches out to an audience of employees, who are not using computers, or may not have the financial resources to purchase a computer. Further, the system provides rewards based on the actions and events participated by the employee in various steps of the recruiting process.

The foregoing description comprises illustrative embodiments of the present invention. Having thus described exemplary embodiments of the present invention, it should be noted by those skilled in the art that the within disclosures are exemplary only, and that various other alternatives, adaptations, and modifications may be made within the scope of the present invention. Merely listing or numbering the steps of a method in a certain order does not constitute any limitation on the order of the steps of that method. Many modifications and other embodiments of the invention will come to mind to one skilled in the art to which this invention pertains having the benefit of the teachings presented in the foregoing descriptions. Although specific terms may be employed herein, they are used only in generic and descriptive sense and not for purposes of limitation. Accordingly, the present invention is not limited to the specific embodiments illustrated herein.

1. A web-based employee referral system, the employee referral system having processor-executable instructions stored thereon that, when executed by at least one processor, the employee referral system comprising:
an employer module includes a web server system via a network connection configured to create, monitor and control one or more sub-modules of the employee referral system, wherein the employer module comprising:
an employee segmentation sub-module configured to:
creating one or more groups for a plurality of employees, and defining the groups by one or more categories for the employees;
an employee record sub-module configured to:
uploading one or more data of the employees into a database of the employee referral system;
assigning one or more employees to each category of the groups,
assigning one or more reward points for the employee to accomplish a preset action; and
redeeming the reward points to the employee accomplishing the preset action,
an advertisement sub-module configured to:
generating a job advertisement using one or more templates and forms;
uploading one or more multimedia data in the advertisement;
providing a communication option in the advertisement for the employee to share the advertisement; and
providing a referral option in the job advertisement for the employee to send one or more data of a referral to the employer,
a campaign sub-module configured to:
providing an option to select a specific generated job advertisement retrieved from the database; and
providing an option to select groups and categories of the employees relevant to the job advertisement, and,
simultaneously, sending the job advertisement via a text messaging application program interface (API) to the mobile devices of the selected employees,
a reward sub-module configured to:
setting the reward points for accomplishing one or more customizable preset actions for the referral by the employees;
defining and customizing the reward points for accomplishing one or more preset actions for the referral by the employees;
defining and customizing the reward points for customizable employer-candidate preset events,
displaying a status of the reward points for accomplishing one or more preset actions for the referral by the employees;
an employee module includes a mobile device configured to receive the job advertisement, or a text message containing a link to the job advertisement, and status of the reward points from the employer module, wherein the communication option in the advertisement enables the employee to share the advertisements, and wherein the referral option in the advertisement enables the employee to send the data of one or more referrals to the employer; and
an administrator module includes a cloud device comprising one or more sub-modules, configured to manage the employer and the employee modules by a service provider.

2. The employee referral system of claim 1, wherein the multimedia data is relevant to the job are audio, video or combination thereof.

3. The employee referral system of claim 1, wherein the advertisement sub-module is provided with an option to share the advertisement via message in a social network or contacts in the device.

4. The employee referral system of claim 1, wherein the advertisement sub-module further comprises information one or more open and closed jobs.

5. The employee referral system of claim 1, wherein the campaign sub-module configured to send the job advertisement via text message to the mobile device of the selected employees.

6. The employee referral system of claim 1, wherein the employee module further comprises a reward sub-module and a query sub-module.

7. The employee referral system of claim 6, wherein the reward sub-module comprises information on awarded and redeemed reward points, and a reward brochure.

8. The employee referral system of claim 6, wherein the query sub-module comprises a form to raise query from the employee.

9. The employee referral system of claim 1, wherein the administrator module further comprises manage employer sub-module, activity tracking sub-module, and billing and payment sub-module.

10. The employee referral system of claim 9, wherein the manage employer sub-module is configured to add, edit or delete one or more employer information.

11. The employee referral system of claim 10, wherein the employer information includes company name, department, name, billing, and contact information.

12. The employee referral system of claim 9, wherein the activity tracking sub-module is configured to view, monitor, and extract one or more data.

13. The employee referral system of claim 9, wherein the billing and payment sub-module is configured to provide an option for the employer/customer to view the status of the billing and payment.
